(19) United States
(12) Patent Application Publication
(10) Pub. No.: US 2012/0159374 A1
(43) Pub. Date: Jun. 21, 2012

(54) OPERATION METHOD OF E-BOOK

(75) Inventor: Su-Cheng Liu, Hsinchu (TW)

(73) Assignee: E Ink Holdings Inc., Hsinchu City (TW)

(21) Appl. No.: 13/041,540

(22) Filed: Mar. 7, 2011

(30) Foreign Application Priority Data
Dec. 15, 2010 (TW) 099143991

(51) Int. Cl. G06F 3/048

(52) U.S. Cl. 715/776

(57) ABSTRACT

An exemplary operation method is applied to an architecture having a function of reading. The architecture is selected from one of a hardware architecture and a software architecture. In particular, the operation method includes the step of: adding a function of reading assistance to the architecture by applying at least a reading assistance command to the architecture. The at least a reading assistance command for example includes a TAB command for tab labeling in the architecture.

### FIELD OF THE INVENTION

The present invention generally relates to edit tools, and more particularly to an edit tool for electronic book (e-book).

### BACKGROUND OF THE INVENTION

With the progress of science and technology, it is becoming more and more popular for people to make knowledge and content be digital documents to facilitate the other persons to read such documents by electronic devices. In order to meet different requirements, more and more software are provided. Generally speaking, such software have their particular content formats, a document creator can use an edit function of the software to edit the content into a digital document with particular format, and a reader can use a reading function of the same software to read the digital document with the particular format. However, the edit function of the software generally is focused on how to make the content into a certain format and how to present the content in a best manner, but ignore the convenience of reading for the reader.

An electronic book (e-book) is taken as an example, the e-book currently uses several types of formats such as TXT, PDF and ePub as its primary storage formats. When the reader uses a personal computer (PC) or a mobile phone for reading, the reader basically uses the software to perform some reading functions such as scroll, page up/down, GOTO (skip several pages or jump to target page) or search. If the reader uses the e-book reader for reading, such functions can be carried on by software or hardware (e.g., functional keys). However, the above reading functions are generic functions and without any difference with respect to different e-books or digital documents, and thus lack of reading convenience for different contents. It is obvious that such limited functions would not satisfy the requirements of users.

Recently, some e-book readers in the market provide a function that allowing readers to add annotates and search added annotates, however, the annotate add and search function only can be used by the reader, the creator of the document or e-book could not use such function.

PowerPoint presentation software uses a special way to provide limited functions (e.g., jump to a specific slide), the emphasis is to make presentation, the reader could not make any change to such limited functions.

Similarly, as to the web browser software, the creator of document can add a hyperlink, and the reader can use the hyperlink to link a reference material designated by the document creator and then return back to the original web page.

In short, the above software use different ways to unilaterally provide some limited functions, but could not comprehensively and systematically provide the convenience similar to printed material reading for readers.

### SUMMARY OF THE INVENTION

Therefore, an objective of the present invention is to provide an operation method, so as to satisfy user's demand.

In particular, an operation method in accordance with an embodiment of the present invention is applied to an architecture having a first function. The operation method comprises a step of: adding a second function different from the first function to the architecture.

In one embodiment, the above mentioned architecture can be a hardware architecture such as a digital document reader, or a software architecture such as a digital file.

An operation method in accordance with another embodiment of the present invention is applied to an architecture having a function of reading. The architecture is selected from one of a hardware architecture and a software architecture. In particular, the operation method includes the step of: adding a function of reading assistance to the architecture by applying at least a reading assistance command to the architecture. The at least a reading assistance command for example includes a TAB command for tab labeling in the architecture.

Owing to a new function(s) different from original function of the architecture is added to the architecture, the present invention makes the architecture to be more conveniently used by users.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a diagram that schematically illustrates an operation method in accordance with a preferred embodiment of the present invention;

FIG. 2 is a system block diagram that schematically depicts a portable electronic device in accordance with a preferred embodiment of the present invention; and

FIG. 3 is a schematic diagram that illustrates effects of reading assistance commands issued to the e-book application in accordance with a preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

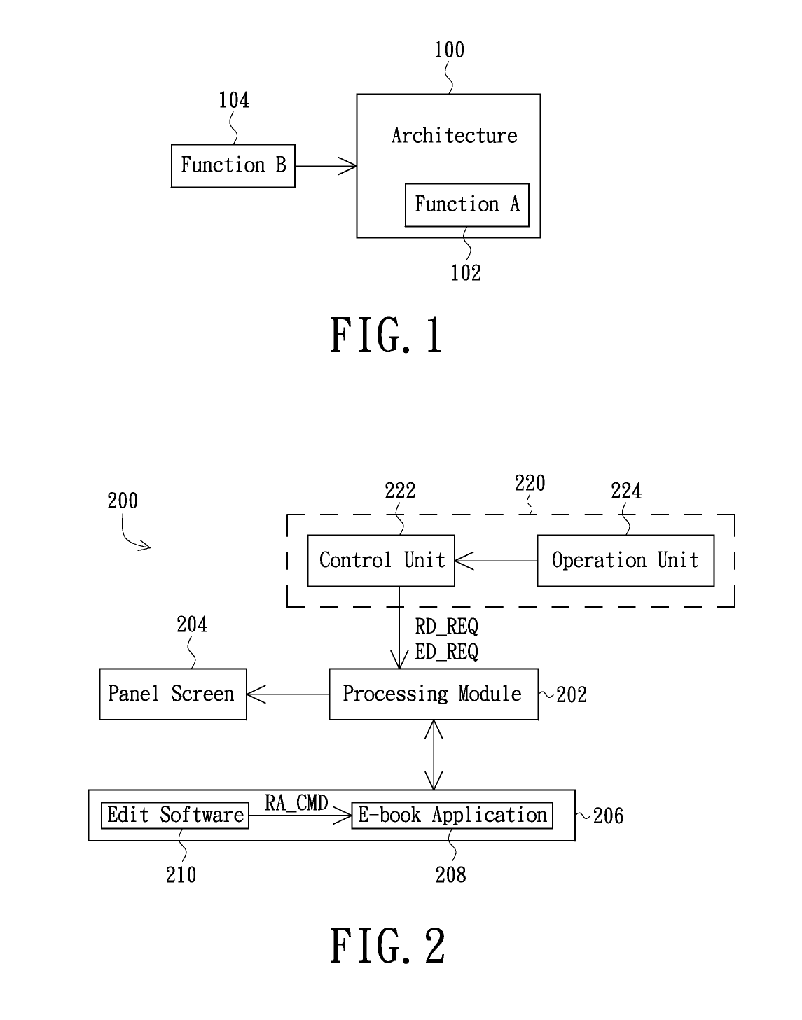

FIG. 1 is a diagram that schematically illustrates an operation method in accordance with a preferred embodiment of the present invention. As depicted in FIG. 1, in the illustrative embodiment, the architecture 100 originally has a function A 102, and a function B 104 different from the function B 104 is added to an architecture 100, so that the architecture 100 of the present invention have more functions to satisfy the requirement of user.

In an embodiment, the architecture 100 is a hardware architecture such as a portable electronic device. FIG. 2 is a system block diagram that schematically depicts a portable electronic device in accordance with a preferred embodiment of the present invention. As depicted in FIG. 2, the portable electronic device 200 for example a digital document reader comprises a processing module 202, a panel screen 204 and a storage unit 206. The processing module 202 is coupled to both the panel screen 204 and the storage unit 206. The panel screen 204 for example is a liquid crystal display (LCD) panel screen, or a bistable panel screen including an electrophoretic panel screen. In addition, the panel screen 204 can be a touch panel screen instead.

Still referring to FIG. 2, the storage unit 206 can be an internal storage device such as a hard drive, or an external storage device such as a memory card, an USB pen drive, etc. In an embodiment, the portable electronic device 200 may further comprise an operation module 220. The operation module 220 comprises a control unit 222 and at least one operation unit 224. The operation unit 224 is coupled to the control unit 222, and the control unit 222 is further coupled to the processing module 202. The operation unit 224 can be entity keys, a touch pad, a joystick, a trackball or any combination thereof. As depicted in FIG. 2, when a user operates the operation unit 224, the control unit 222 accordingly issues a corresponding control signal to the processing module 202 based on a status of the operation unit 224. The processing module 202 then controls the operating/running of the portable electronic device 200 based on the control signal outputted from the control unit 222.

In another embodiment, the architecture 100 of FIG. 1 is a software architecture such as a digital file instead, and the digital file can be installed to the storage unit 206 of FIG. 2. Still referring to FIG. 2, in the illustrative embodiment, the digital file installed in the storage unit 206 can be an e-book application 208 for displaying multiple image pages. It is understood to the skilled person in the art that the digital file is not limited to the e-book application, and may be a PowerPoint presentation application, a Word application or an Excel application, etc.

Still referring to FIG. 2, when a user triggers a read request RD_REQ by the operation module 220, the operation module 220 will send the read request RD_REQ to the processing module 202. The processing module 202 then responds to the read request RD_REQ and runs the e-book application 208 in the storage unit 206 to thereby display an e-book on the panel screen 204.

Particularly, in the illustrative embodiment, an edit software 210 is installed to the storage unit 206 as depicted in FIG. 2. When the user (e.g., editor or reader of digital file) triggers an edit request ED_REQ by the operation module 220, the edit software 201 accordingly is run/executed. After the edit software 210 is executed, a reading assistance command RA_CMD can be issued by the edit software 210 to the e-book application 208 based on user's demand. Such reading assistance command RD_CMD facilitates the e-book application 208 to have other additional function besides some basic functions relevant to reading.

More specifically, the reading assistance command RA_CMD can be a TAB command. When the TAB command is issued from the edit software 210 to the e-book application 208, a TAB tool is accordingly displayed on a reading image page displayed by the e-book application 208. Once the user clicks the TAB tool, a tab can be set at a position marked by a cursor in the reading image page displayed by the e-book application 208 and thereby a tab symbol is displayed at the position marked by the cursor.

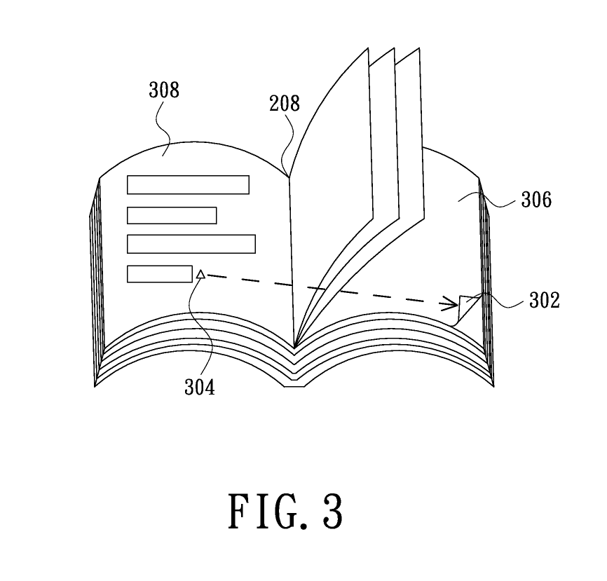

FIG. 3 is a schematic diagram that illustrates effects of reading assistance commands issued to the e-book application 208 in accordance with a preferred embodiment of the present invention. Please refer to both FIGS. 2 and 3, in the illustrative embodiment, when one of the image pages displayed by the e-book application 208, e.g., the image page 306 is set with a tab, which is similar to fold a corner of a page of substantial book, e.g., the folded-corner 302. Such reading assistance command of TAB only is for labeling and no any execution if the TAB symbol is touched or applied with any other action.

Moreover, the edit software 210 further may issue another RA_CMD, e.g., a GOTO TAB command according to a corresponding operation of the user. When the e-book application 208 receives the GOTO TAB command, a GOTO TAB tool e.g., 304 will be displayed on a reading image page 308 displayed by the e-book application 208. When the user clicks the GOTO TAB tool 304, the reading image page displayed on the panel screen 204 by the e-book application will be switched to a image page such as the page 306 labeled with a tab symbol.

The GOTO TAB command can provide several advantages. For example, one of the advantages is that the GOTO TAB command can help the user to jump from a chapter directory directly to corresponding chapter content, and another of the advantages is that the GOTO TAB command can help the user to easily jump to a reference material.

It is noted that the reading assistance commands such as the above TAB command and GOTO TAB command provided from the edit software to the e-book application 208 are categorized to visible commands due to these commands are related to visible symbols or tools. However, the edit software 210 is not limited to provide visible commands, and can further provide invisible commands. Herein, an invisible command is a type of command relevant to no any visible symbols or tools are necessary to be displayed on the panel screen 204 for the execution of the invisible command.

Specifically, in an optional embodiment, the edit software 210 not only can provide a new function(s) to the e-book application 208, but also can provide a new function(s) to the reader device 200. For instance, the edit software 210 can issue a reading assistance command RA_CMD to the portable electronic device 200, e.g., a NEXT TAB command (i.e., a type of invisible command). When the edit software 210 issues the NEXT TAB command to the reader device 200, the operation unit 224 is defined with a new function, e.g., an entity key or virtual key is given a new function. In the illustrative embodiment, when the user is reading an image page with a tab displayed by the e-book application 208, if the user enables the new function of the operation unit 224, the image page with the tab displayed on the panel screen 204 by the e-book application 208 will jump to the next image page with a tab. Accordingly, such NEXT TAB command can be used to help the user to quickly jump to the next chapter or the next reference material. In another embodiment, the user can use an invisible-command list to trigger such NEXT TAB command.

Moreover, the edit software 210 further can issue another reading assistance command RA_CMD to the portable electronic device 200, e.g., a RETURN command (i.e., another type of invisible command). When the edit software 210 issues the RETURN command, the operation unit 224 is re-defined with another new function. In this situation, when the panel screen 204 displays an image page with a tab by the e-book application 208, the user can trigger re-defined the operation unit 224 so as to switch back the previous image. Likewise, the user can also use the invisible-command list to trigger the RETURN command. By use of the RETURN command, after executing the above GOTO TAB command, the user can quickly go back to the original image page.

In the present invention, the above user can be a reader as well as an editor. By implementing the above embodiments, it is easy to allow a user to change from a n edit status to a reading status, vice versa. Once the user adds tabs or annotates in the digital file e.g., the e-book application 208, the user can make the tabs or annotates combined with the digital file, so that the tabs or annotates have the portable characteristic.

Although in the above embodiments, the reading assistance commands RA_CMD can be produced from the edit software 210, in other embodiments, such reading assistance commands RA_CMD can be provided from a hardware system instead. For example, the processing module 202 in the portable electronic device 200 also can be used for providing such reading assistance commands.

Additionally, although multiple reading assistance commands have been illustrated as examples, it is not to limit the present invention. The skilled person in the art can flexibly set wanted reading assistance command(s) according to actual requirement.

To sum up, in the present invention, the user is facilitated to add a new function(s) to the hardware or software architecture 100 according to actual requirement, and therefore the operation method in accordance with the present invention can allow the architecture 100 to be endowed with more functions to satisfy user's needs.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operation method applied to an architecture having a first function, the operation method comprising a step of:
adding a second function different from the first function to the architecture.

2. The operation method according to claim 1, wherein the architecture is hardware.

3. The operation method according to claim 2, wherein the architecture is a digital document reader.

4. The operation method according to claim 1, wherein the architecture is software.

5. The operation method according to claim 4, wherein the architecture is a digital file.

6. The operation method according to claim 5, wherein the digital file is an electronic book application .

7. The operation method according to claim 5, wherein the step of adding a second function different from the first function to the architecture comprises:
applying at least one reading assistance command to the digital file.

8. The operation method according to claim 7, wherein the at least one reading assistance command comprises a TAB command for labeling at least one of multiple image pages displayed by the digital file each with a tab and displaying the tab on a reading image page displayed by the digital file.

9. The operation method according to claim 8, wherein the at least one reading assistance command comprises a GOTO TAB command adapted to be displayed on a reading image page displayed by the digital file; and after the GOTO TAB command is triggered, the reading image page displayed by the digital file is switched to an image page labeled with the tab.

10. The operation method according to claim 8, wherein the at least one reading assistance command comprises a NEXT TAB command, and after an entity key is triggered to enable the NEXT TAB command, a currently-displayed image page with the tab displayed by the digital file is switched to the next image page with the tab.

11. The operation method according to claim 7, wherein the at least one reading assistance command comprises a RETURN command, and after an entity key is triggered to enable the RETURN command, a currently-displayed image page displayed by the digital file is switched back to the previous image page.

12. The operation method according to claim 7, wherein the reading assistance command is created by an edit software.

13. The operation method according to claim 7, wherein the reading assistance command is issued from a hardware system.

14. The operation method according to claim 13, wherein the hardware system is a portable electronic device.

15. An operation method applied to an architecture having a function of reading, the architecture being selected from one of a hardware architecture and a software architecture, the operation method comprising:
adding a function of reading assistance to the architecture by applying at least a reading assistance command to the architecture;
wherein the at least a reading assistance command comprises a TAB command for tab labeling in the architecture.

16. The operation method according to claim 15, wherein the at least a reading assistance command further comprises a GOTO TAB command.

17. The operation method according to claim 16, wherein the at least a reading assistance command further comprises at least one of a NEXT TAB command and a RETURN command.
